(19) United States
(12) Patent Application Publication
(10) Pub. No.: US 2019/0139364 A1
(43) Pub. Date: May 9, 2019

(54) GAMING DEVICES HAVING BONUS POKER GAME

(71) Applicant: KING SHOW GAMES, INC., Minnetonka, MN (US)

(72) Inventor: Jacob LAMB, Maple Grove, MN (US)

(21) Appl. No.: 16/183,629

(22) Filed: Nov. 7, 2018

Related U.S. Application Data
(60) Provisional application No. 62/582,945, filed on Nov. 7, 2017.

(51) Int. Cl. G07F 17/32

(52) U.S. Cl. CPC G07F 17/3267; G07F 17/3213; G07F 17/3209; G07F 17/3244; G07F 17/3293

(57) ABSTRACT

Embodiments of the present invention set forth systems, apparatuses and methods for to provide game play that utilizes operations of bonus poker game features in gaming devices. Accordingly, a gaming device can be configured to provide a player with a card when a condition is met during a gaming event. The collected cards can then be used to form poker hands that are evaluated for award values, multipliers, game event modifiers, or other prizes.

### RELATED APPLICATIONS

This application claims the benefit of Provisional Patent Application No. 62/582,945, filed on Nov. 7, 2017, to which priority is claimed pursuant to 35 U.S.C. §119(e) and which is incorporated herein by reference in its entirety.

### FIELD OF THE INVENTION

This disclosure relates generally to games, and more particularly to systems, apparatuses and methods for implementing a bonus poker game in gaming devices.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate implementing bonus poker games in gaming devices. In one embodiment, a method of operating a gaming device includes providing a player with a card after each gaming event, where a player can form poker hands using the collected cards for award values, multipliers, game event modifiers, or other prizes.

### BRIEF DESCRIPTION OF THE DRAWINGS

FIG. 1 is a diagram of a gaming machine according to embodiments of the invention.

FIG. 2 is a block diagram illustrating a computing arrangement according to embodiments of the invention.

FIGS. 3A and 3B are detail diagrams of a gaming device showing a bonus poker game according to embodiments of the invention.

FIG. 4 is a detail diagram of a gaming device showing a bonus poker game according to embodiments of the invention.

FIGS. 5A, 5B, 5C, 5D, and 5E are detail diagrams of a gaming device showing a game progression using a bonus poker game according to embodiments of the invention.

FIGS. 6A, 6B, 6C, 6D, and 6E are detail diagrams of a gaming device showing another game progression using a bonus poker game according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for implementing customizable bonus features in gaming activities. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that utilizes operations of bonus poker game features in gaming devices. In one embodiment, a method of operating a gaming device includes providing a player with a card after each gaming event, where a player can form poker hands using the collected cards for award values, multipliers, game event modifiers, or other prizes.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, or other games of chance. Some of these other types of embodiments will be discussed below as variations to the examples illustrated. However, many other types of games can implement similar techniques and fall within the scope of this inventive concept.

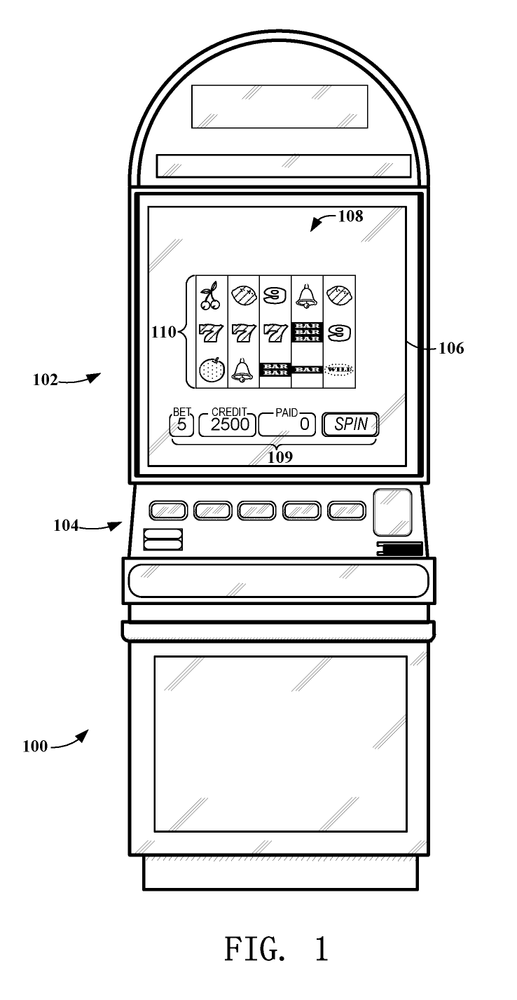

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

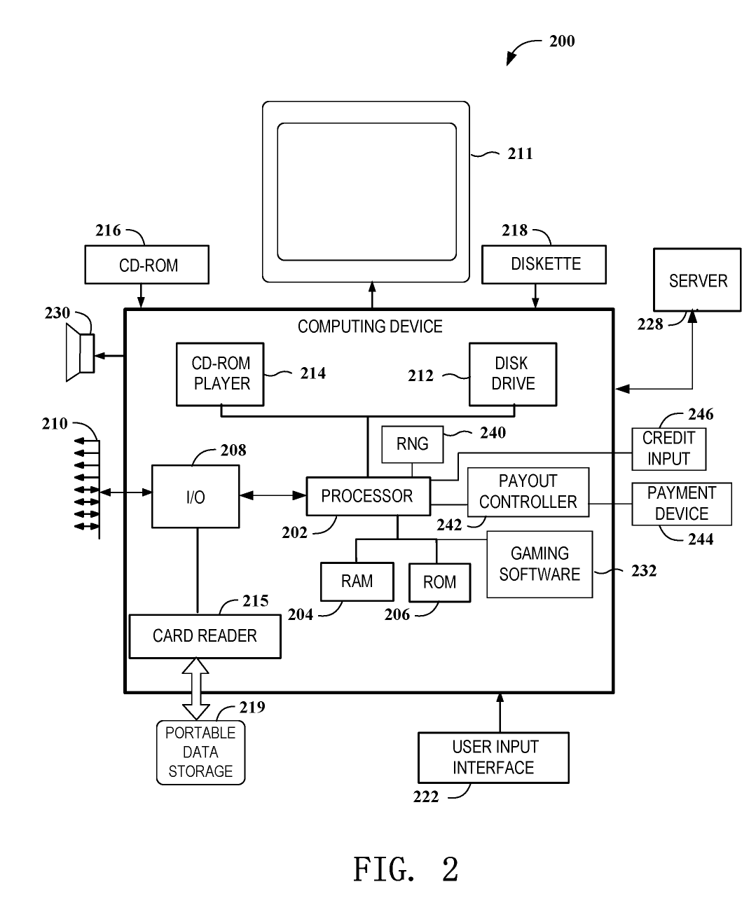

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player loyalty information to identify a user or player of the gaming device. This mechanism may be card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some the example embodiments illustrated herein, the primary gaming portion 108 may display a grid (or equivalent arrangement) of game elements 110 or game element positions (also referred to as “reel stop positions” herein). As illustrated in the embodiment shown in FIG. 1, the grid includes three rows and five columns of game elements 110, which may form a game outcome of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as paytables, navigation controls, etc.

Although FIG. 1 illustrates a particular implementation of some of the embodiments of this invention in a casino or electronic gaming machine (“EGM”), one or more devices may be programmed to play various embodiments of the invention. The present invention may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the invention is illustrated in FIG. 2.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 200 of FIG. 2 is an example computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions in accordance with the present invention typically includes a central processor (CPU) 202 coupled to random access memory (RAM) 204 and some variation of read-only memory (ROM) 206. The ROM 206 may also represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to the display 211, which represents a display on which the gaming activities in accordance with the invention are presented. The display 211 represents the “presentation” of the game information in accordance with the invention, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. The present invention is operable using any known RNG, and may be integrally programmed as part of the processor 202 operation, or alternatively may be a separate RNG controller 240. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 indicating a payout is to be made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout device 244 may also be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described hereinabove. For example, the software 232 may present, by way of the display 211, representations of symbols to map or otherwise display as part of a slot-based game having reels. However, in other embodiments, the principles of this concept may be applied to poker games or other types of games of chance. One or more aligned positions of these game elements may be evaluated to determine awards based on a paytable. The software 232 may include instructions to provide other functionality as known in the art or as described and shown herein.

As discussed above, embodiments of the present concept include providing gaming devices, gaming systems, and methods of operating these devices or systems to provide bonus poker features to enhance the game play of gaming events. In some embodiments, a player collects virtual playing cards during play of a base game of a gaming device. The base game may be a video spinning reel game, a mechanical spinning reel game, a video poker game, a keno game, or any other type of game of chance implemented on a gaming device. The virtual cards may be generated and collected in a variety of manners according to different embodiments. In one example, a player may receive a virtual card for each game event they play on the gaming device. In another example, the player may receive one or more virtual cards based on receiving one or more trigger conditions, such as sub-symbol overlays appearing on the game grid during the base or primary gaming event. In yet other embodiments, virtual playing cards may appear as symbols on the reel strips of a spinning reel game. When a playing card appears on the game grid as the result of a gaming event, the playing card is collected and the space previously occupied by the playing card may become a wild symbol, or alternatively, may cause the symbols above the empty grid location to cascade down to fill the empty grid location. In still another embodiment, an independent reel may be spun in the empty space to generate a new symbol. In this example embodiment, the reel symbols on the independent reel may include favorable symbols, such as wild symbols, bonus initiator symbols, multiplier symbols, scatter symbols, major symbols, and/or other beneficial symbols.

Once a predefined number of cards are collected, an evaluation process may be eligible to take place to provide a bonus award, a game modifier such as a multiplier, additional wild symbols, locked symbol stacks, etc. In some embodiments, the predefined number of cards may be five cards so that a poker hand can be evaluated to determine a type and/or value of a bonus prize/modifier is provided. The evaluation process may be selected by the player so that the award is available on current or future game event, or the evaluation process may be automatically triggered based on a random determination or a predefined condition being satisfied.

In one embodiment, a player playing a gaming device with a spinning reel slot game of chance starts with an empty bonus deck. After each game (or hand if the base game is a video poker game), the player gets one of the 52 cards added to their deck. When the player chooses, they can “deal out” their deck and get paid for the 5 card stud hands that result. If the player waits to get a full 52 card deck, the final two cards are automatically used to create a premium hand.

In some embodiments, the player receives a standard playing card on each spin to add to their deck (no duplicates, face down). At any time, the player can “deal out” their cards into randomly generated 5-card stud hands. Those hands may be paid based on a poker or other paytable. In some embodiments, if the player does not have a full 52 card deck, and the number of cards they have is not a multiple of five, they lose the extra cards they have. This may encourage them to play a few extra hands to make their number of cards a multiple of five. In other embodiments, the extra cards not divisible by 5 remain in the players deck and may be used in the future. If they player accumulates a full 52 card deck, then they may be dealt out 10 5-card stud hands and then the final two cards will be used to generate a hand on the following schedule:

| Premium Hand | Award Value |
|---|---|
| AK suited | Royal Flush |
| Any Adjacent Suited | Straight Flush |
| Any Pair | Quads |
| Any Adjacent Non-Suited | Straight Flush |
| Any Other | Full House |

In other embodiments, the premium hand may be evaluated against a paytable having credit values. In still other embodiments, the premium hand may generate a multiplier that can be used to multiply any other awards won from the evaluation of the other poker hands and/or used on any awards associated with symbol or card combination in the base/primary game. In other embodiments, the paytable for the premium hand could be the same or different than the paytable for the 5-card stud hands

In some embodiments, a player may be able to see the cards as they get them (i.e., the collected cards are provided face-up). This may allow the player to potentially collect or deal out early if they think the current deck has a high chance of a good payout. However, the player may still lose the possibility of the premium hand using the last two cards

In still other embodiments, duplicate cards may be allowed. Here, there may not be bonus for saving 52 cards since there are duplicates. Alternatively, a different bonus threshold may have be reached to get a premium hand or other type of bonus. For example, if a player reaches 50 cards, any duplicate cards may be associated with a multiplier value. Thus, a pair or more may pay extra.

In other embodiments, a draw poker game may be used instead of a stud-poker game. Here, the player may need at least 10 cards to play the draw poker game. Any unused cards may stay in the hand to be used in the future.

The figures described below illustrate some of the embodiments of this concept. However, many other variations are possible as evidenced by the description above.

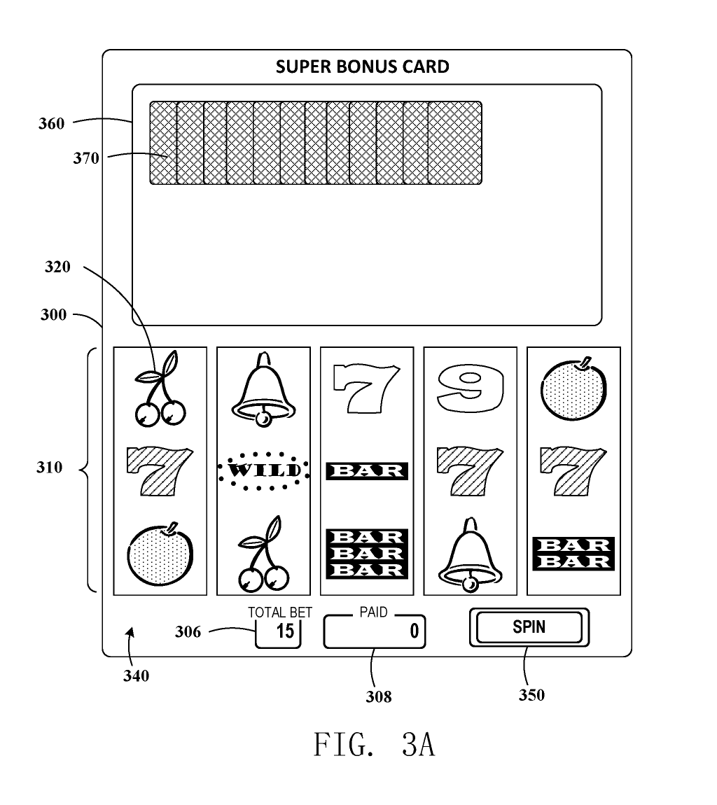

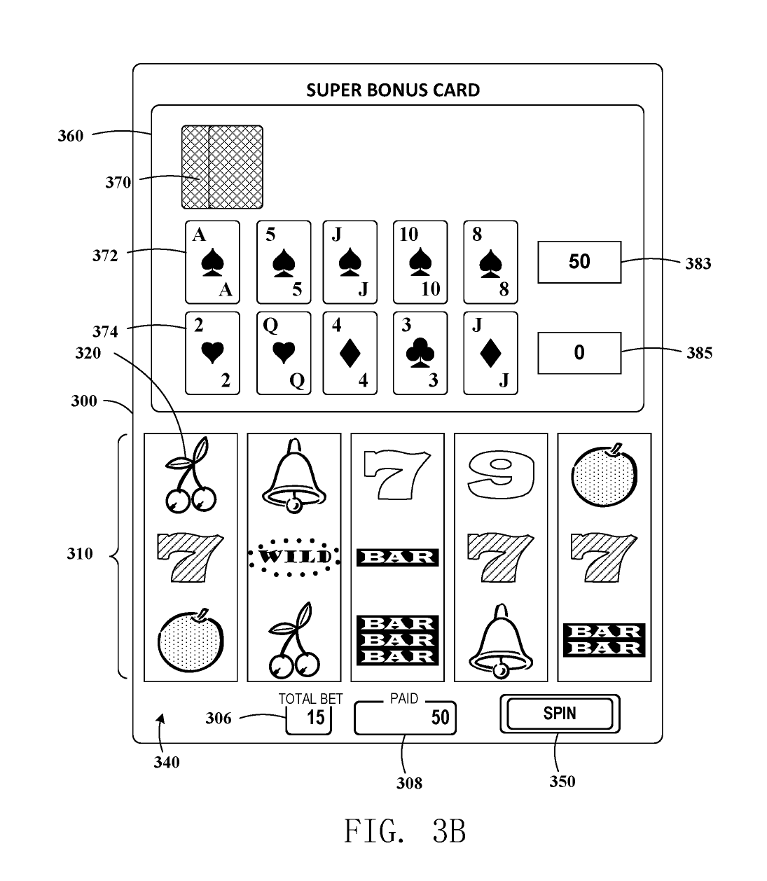

FIGS. 3A and 3B are detail diagrams of a gaming device showing a bonus poker game according to embodiments of the invention. Referring to FIG. 3A, a gaming device 300 includes a game grid 310 in a primary game play area, a secondary or bonus display portion 360. The game grid 310 in a primary game play area and the bonus display portion 360 may be included in a single video display device, where each of the game grid and bonus display are areas of the singular video display, which may or may not overlap and/or replace each other during gaming or non-gaming activities. In other embodiments, the game grid 310 in a primary game play area may be included on a separate video display device from the bonus display portion 360. The gaming device 300 may also include a player interface portion 340, which may appear on either or both of the primary game play area and the bonus display portion 360. The player interface portion 340 may include a variety of buttons, meters, messaging areas, and/or other features that are capable of outputting data to the player or receiving player inputs. The player interface portion 340 of the gaming device 300 illustrated in the embodiment of FIG. 3A includes a Spin button 350, a Total Bet meter 306, and a Paid meter 308. There may, however, be fewer or additional mechanisms included in the player interface portion 340.

In this embodiment, the game grid 310 displays portions of five game reels that each have multiple game symbols 320. In the embodiment shown in FIG. 3A, the bonus display portion 360 may be configured to collect and/or display virtual playing cards 370. In the embodiment shown in FIG. 3A, the collected virtual cards are shown face down so that the player does not know which virtual cards from the deck have been collected so far.

Referring to FIG. 3B, an evaluation process has been triggered. As discussed above, an evaluation process may be triggered by a player after such action becomes eligible to the player. In other embodiments, the evaluation process may be triggered by a predefined condition being satisfied, such as an evaluation symbol or sub-symbol overlay appearing on the game grid 310. In yet other embodiments, a random process may be used to determine when an evaluation process is triggered. In these embodiments, as more virtual cards are collected, the probability of the evaluation process being triggered may increase. For example, with less than 5 cards collected, there may be a 0% chance that the evaluation process is triggered. When 5 to 10 cards have been collected, there may be a 1 in 20 chance that the evaluation process is triggered. When 11 to 20 cards have been collected, there may be a 1 in 10 chance that the evaluation process is triggered. When 21 to 30 cards have been collected, there may be a 1 in 5 chance that the evaluation process is triggered. When 31 to 50 cards have been collected, there may be a 1 in 3 chance that the evaluation process is triggered. If all 52 cards have been collected, there is a 100% chance that the evaluation process will be triggered.

As shown in FIG. 3B, when an evaluation process is triggered, one or more hands of poker is evaluated to determine a bonus award or bonus game modifier. In some embodiments, only a certain number of poker hands may be evaluated as part of the evaluation process. That is, not all of the collected cards may be evaluated during an evaluation process. This may be because an odd number of cards have been collected such that even numbered 5-card poker hands cannot be completed. However, in other embodiments, there may be random or predefined selection process to determine how many poker hands are evaluated.

Returning to FIG. 3B, a first 5-card stud poker hand 372 and a second 5-card stud poker hand 374 is randomly dealt out of the collection of face down cards 370. Any remaining collected cards 370 will remain face down and may be used in future evaluation processes. In other embodiments, less or more cards may be used in the poker hands during the evaluation process (e.g., 3-card stud poker hands, etc.). In yet other embodiments, the poker hands may be draw poker hands where the player can hold and replace non-held cards to generate a final poker hand for evaluation purposes. The replacement cards may be drawn from other collected cards, or may be randomly drawn from a separate virtual deck of cards (where, in some embodiments, the collected cards have been removed from the deck).

In FIG. 3B, after each of the first and second 5-card stud poker hands 372, 374 are evaluated, any prizes determined during the evaluation process is are shown in corresponding bonus award meters 383, 385. In this instance, the first 5-card stud poker hand is a flush and is associated with a bonus credit award of 50 credits, as shown in the first bonus award meter 383. The second 5-card stud poker hand, however, is not associated with any awards. The awards determined during the evaluation process may then be provided to the player as shown in the Paid meter 308.

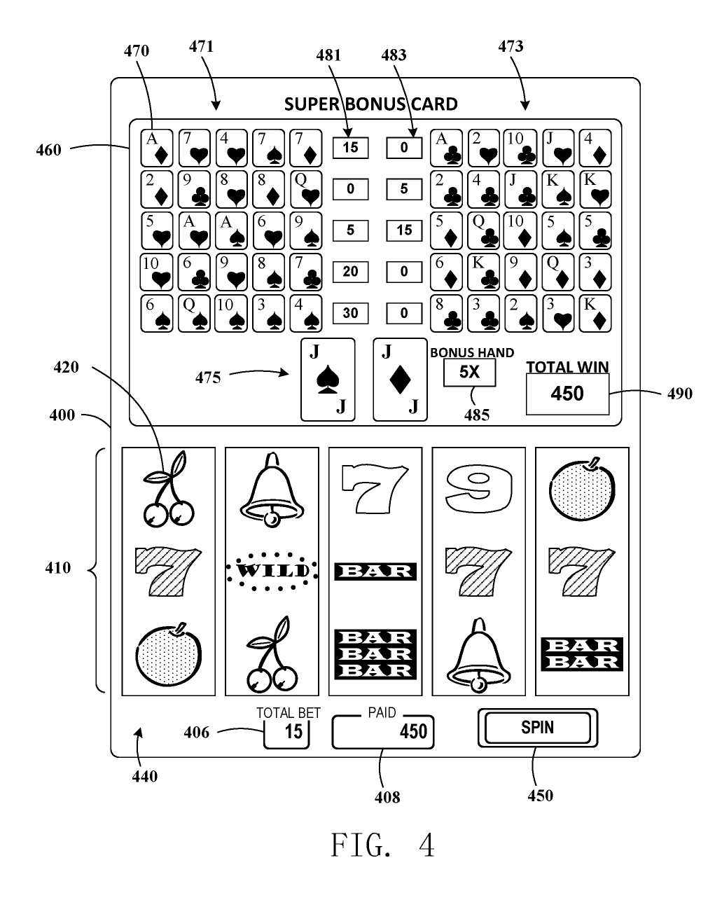

FIG. 4 is a detail diagram of a gaming device showing a bonus poker game according to embodiments of the invention. Referring to FIG. 4, a gaming device 400 includes a game grid 410 showing symbols 420 from a plurality of game reels, and bonus display portion 460 showing collected virtual cards 470. The gaming device 400 may also include a player interface portion 440 that includes various player input devices or output displays, such as a Spin button 450, a Total Bet meter 406 and a Paid meter 408. In the embodiment shown in FIG. 4, a player has collected all 52 virtual cards 470 during game play of the primary or base game and an evaluation process has been initiated. Here, the collected, virtual cards 470 are randomly placed into ten 5-card stud poker hands 471, 473 and the remaining two virtual cards are placed in a premium two-card stud hand 475. Each of the ten 5-card stud poker hands are evaluated and awards are reflected in the corresponding hand award meters 481, 483. Here, the paytable associate with the stud poker hands provides credit awards for any card combinations that appear on the paytable. In this embodiment, however, the premium hand 475 is evaluated against a 2-card stud paytable that is associated with multiplier values. The bonus hand meter 485 shows the multiplier associated with the evaluated premium hand 475.

In some embodiments, the paytables for the poker hands may have minimum awards such that the player is guaranteed to win something for each hand evaluated. For example, in one embodiment, the minimum a player will win for each evaluated 5-card stud poker hand is 5 credits and the minimum multiplier that the player can receive for the evaluation of the premium hand is “2×”. Hence, the lowest bonus value the player could win is 100 credits. This would again encourage a player to try to collect all of the cards so that they would have a chance of maximizing the bonus award size with the premium hand and 10 other hands with potential awards to be multiplied by the multiplier received from the premium hand.

Returning to FIG. 4, once all of the poker hands 471, 473, 475 have been evaluated in the evaluation process, the sum of the award values in the hand award meters 481, 483 is multiplied by the multiplier value in the bonus hand meter 485 and the total bonus award is shown in the total bonus win meter 490. This total bonus win amount is then provided to the player, which is reflected in the paid meter 408.

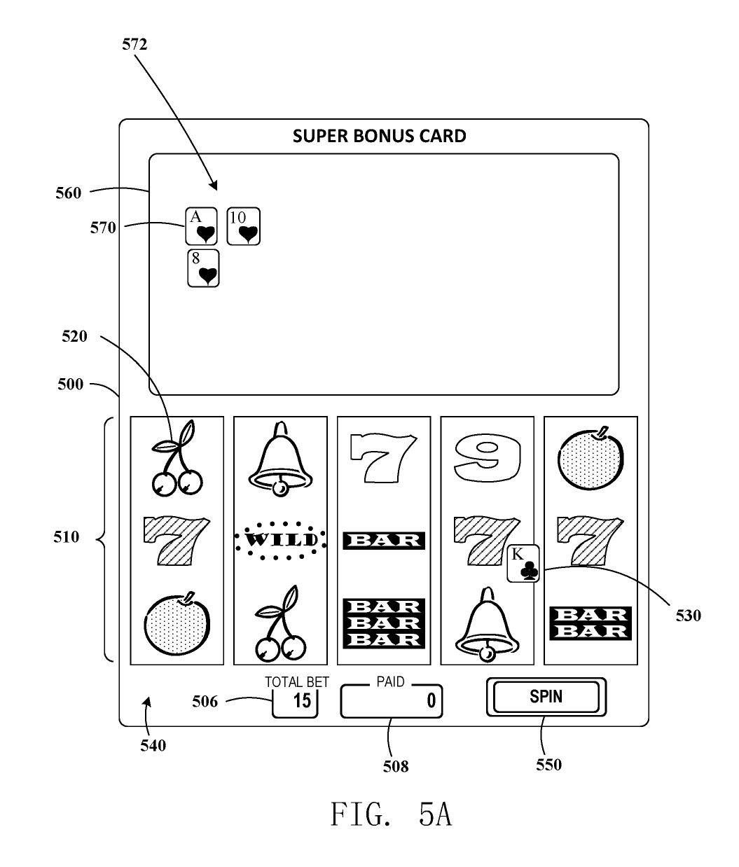

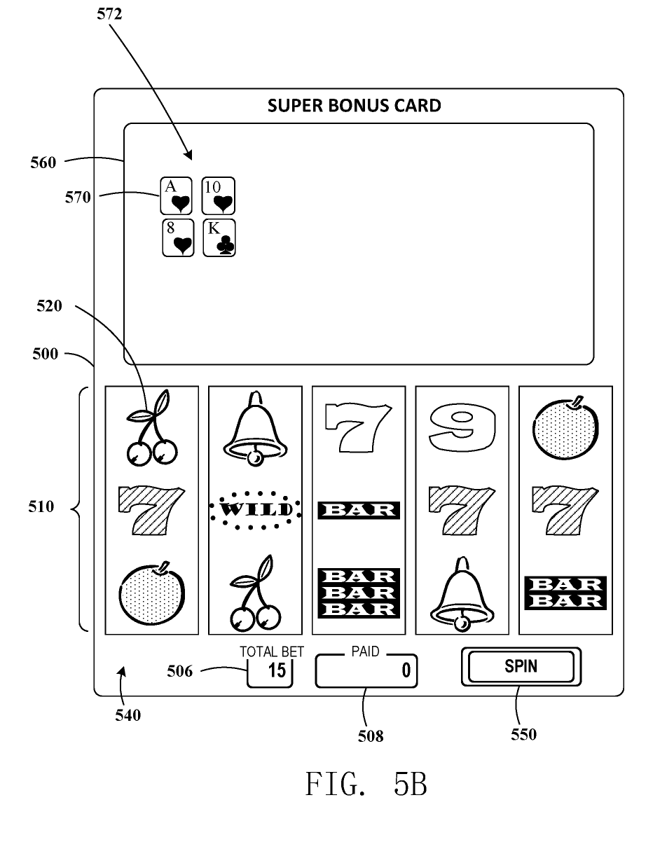

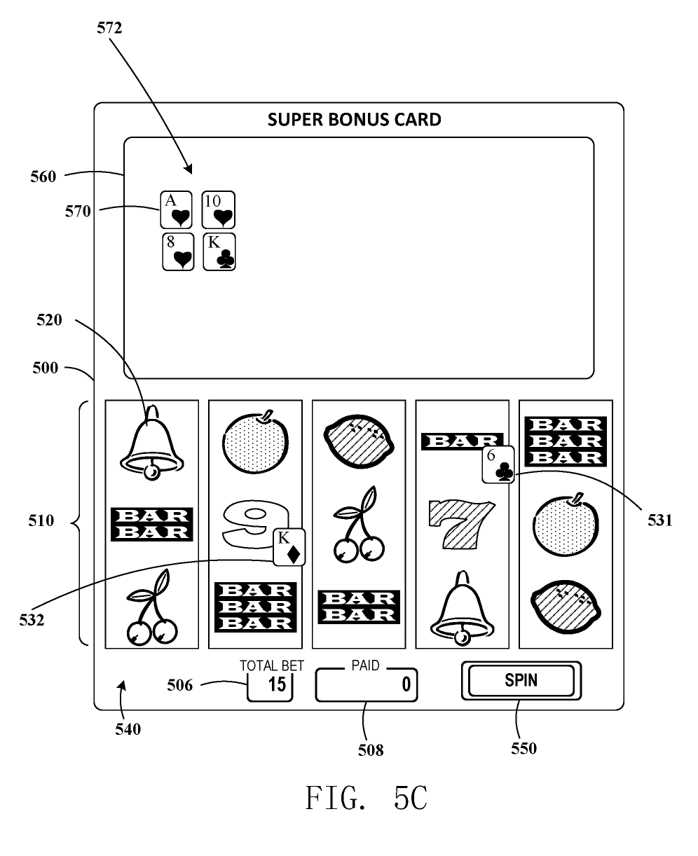

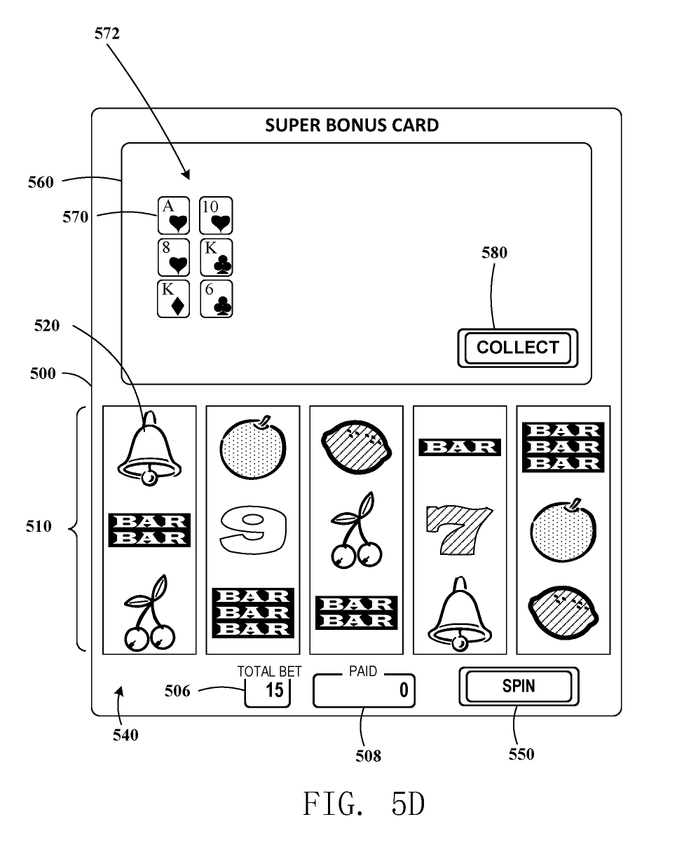

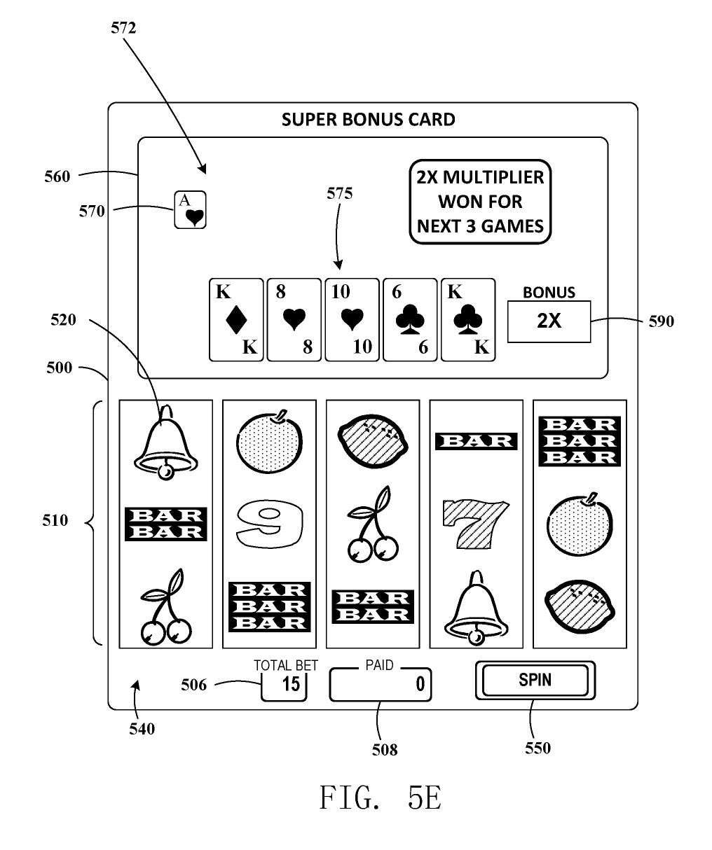

FIGS. 5A, 5B, 5C, 5D, and 5E are detail diagrams of a gaming device showing a game progression using a bonus poker game according to embodiments of the invention. Referring to FIG. 5A, a gaming device 500 includes a game grid 510 showing symbols 520 from a plurality of game reels, and bonus display portion 560 showing a group 572 of collected virtual cards 572. The gaming device 500 may also include a player interface portion 540 that includes various player input devices or output displays, such as a Spin button 550, a Total Bet meter 506 and a Paid meter 508. In the embodiment shown in FIG. 5A, virtual cards 570 are collected when they appear as sub-symbol overlays 530 associated with game symbols 520 on the game grid 510 as a result of a gaming event. In FIG. 5A, three virtual cards 570 have already been collected and are shown face-up in the collection group 572. Additionally, as the result of the latest gaming event on the game grid 510, a sub-symbol overlay 530 showing the King of Clubs. In other embodiments, a sub-symbol overlay 530 may be face-down card or a different bonus symbol, where a virtual card 570 to be collected is selected after the sub-symbol overlay 530 is received in the primary or base gaming event.

Referring to FIG. 5B, the King of Clubs received as the sub-symbol overlay 530 in FIG. 5A is moved up to the collection group 572 in the bonus display portion 560. Referring to FIG. 5C, one or more gaming events have transpired since the primary gaming event shown in FIGS. 5A and 5B. In the primary gaming event shown in FIG. 5C, two more sub-symbol overlays 531, 532 are received in the game outcome shown on the game grid 510. Here, the first sub-symbol overlay 531 is associated with a Six of Clubs, and the second sub-symbol overlay 532 is associated with the King of Diamonds.

Referring to FIG. 5D, the Six of Clubs and King of Diamonds from the first and second sub-symbol overlays 531, 532 shown in FIG. 5C are moved up to the collection of cards 572 in the bonus display portion 560. Additionally, an evaluation process becomes eligible as 5 or more virtual playing cards 570 have been collected 572. In this embodiment, a Collect button 580 is presented to the player, where the player can choose if they want to initiate an evaluation process.

Referring to FIG. 5E, the player has decided to initiate the evaluation process by activating the Collect button 580 shown in FIG. 5D. Here, the best 5 cards from the collection of cards 572 are selected as a 5-card stud poker hand 575 to be evaluated for awards. Note that the Ace of Hearts is not selected in this embodiment as it does not help the pair of Kings, but may be the most valuable card remaining in the collection of cards 572 for future use. In other embodiment, 5 random cards may be selected from the collection of cards 572 to place in the stud poker hand 575 to be evaluated. In yet other embodiments, a player may select the 5 cards that they want to be evaluated in the stud poker hand. In other embodiments, the poker hand for evaluation purposes may be a draw poker hand instead of a stud poker hand. Here, the player may only have the replacement cards available from the remaining virtual cards 570 in the collection of cards 572 or may receive replacement cards from a separate deck (where duplicate cards of the cards in the collection of cards and the dealt draw poker hand may or may not be removed).

Returning to FIG. 5E, the 5-card stud poker hand is evaluated against a poker paytable and a multiplier award (in this case) is provided in the bonus award meter 590. In this embodiment, the bonus multiplier is available to multiply award values over a random number of future gaming events (here, the next 3 gaming events). In other embodiments, other award types or mechanisms may be used when the bonus poker hand(s) is(are) evaluated.

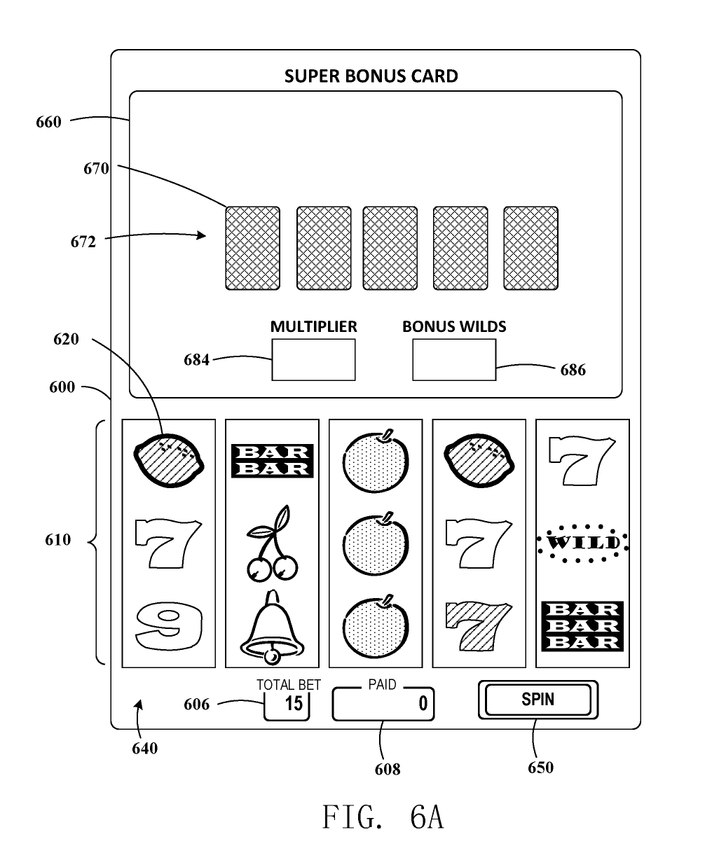

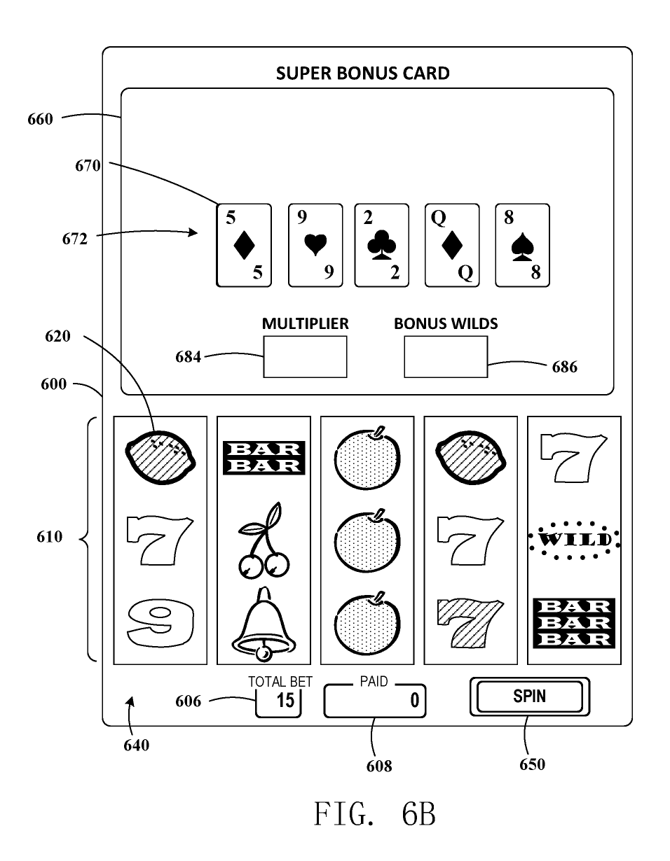

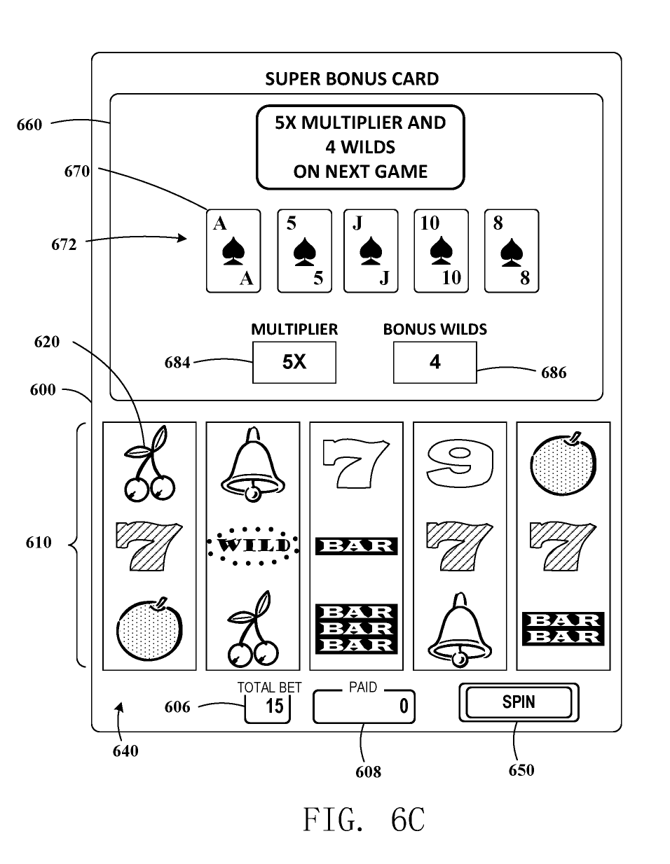

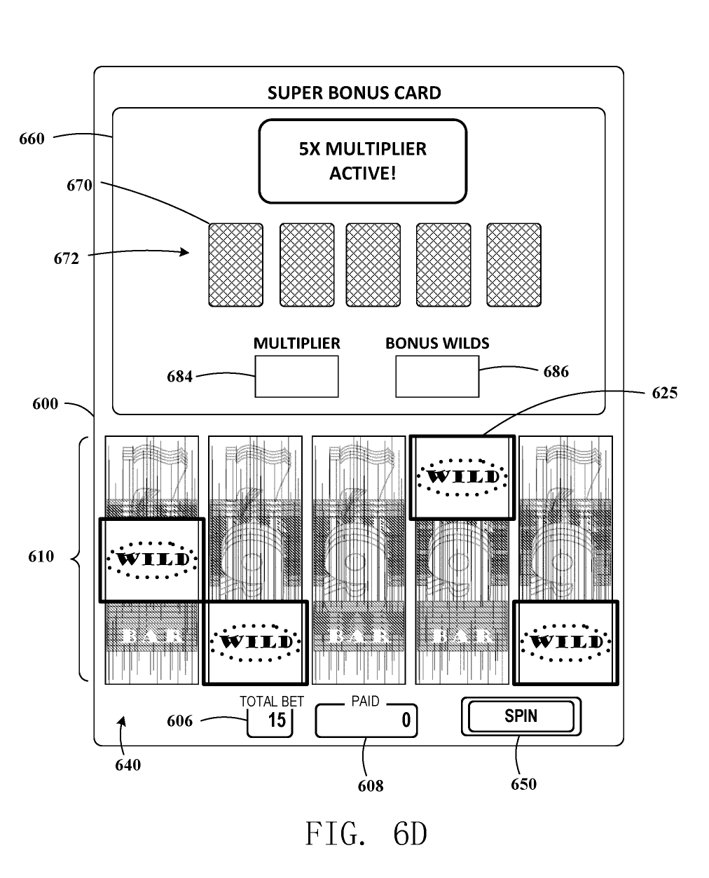

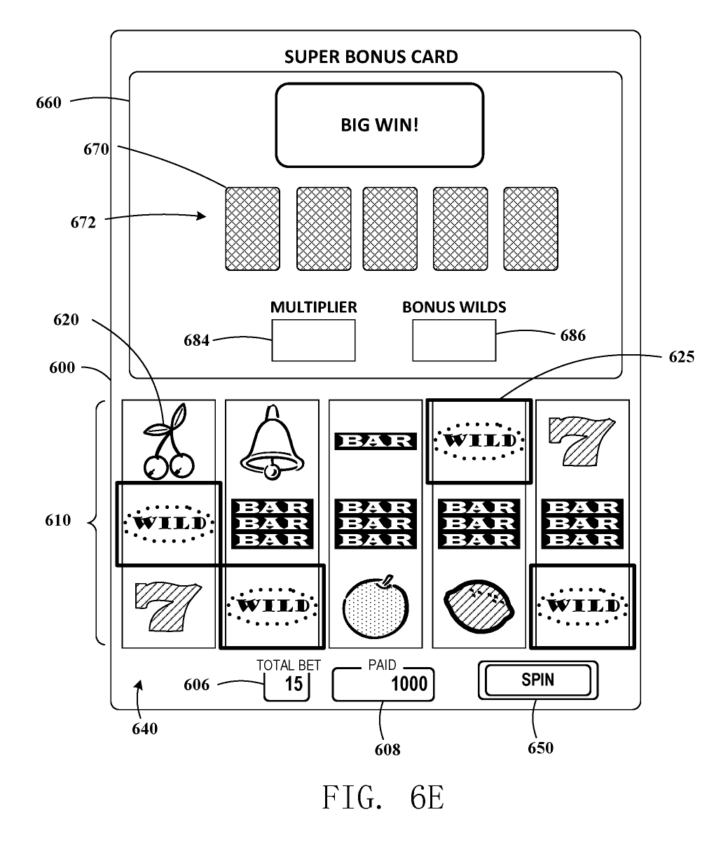

FIGS. 6A, 6B, 6C, 6D, and 6E are detail diagrams of a gaming device showing another game progression using a bonus poker game according to embodiments of the invention. Referring to FIG. 6A, a gaming device 600 includes a game grid 610 showing symbols 620 from a plurality of game reels, and bonus display portion 660 showing a group 672 of collected virtual cards 672. The gaming device 600 may also include a player interface portion 640 that includes various player input devices or output displays, such as a Spin button 650, a Total Bet meter 606 and a Paid meter 608. In the embodiment shown in FIG. 6A five virtual cards 670 are provided for every wagered-on gaming event. The five virtual cards 670 are shown and evaluated after the primary game outcome has been determined and displayed on the game grid 610. In this embodiment, the evaluation of the collected cards may result in a multiplier and/or a number of sticky wilds being used in the next gaming event. A Multiplier meter 684 and a Bonus Wild meter 686 may be shown in the bonus display area to show what the multiplier and number of extra, locked wild symbols will be for the next game. In other embodiments, credit awards, stacks of symbols, free games, or other prizes may be associated with the evaluation of the bonus poker hand.

Referring to FIG. 6B, the virtual cards 670 associated with the first gaming event are revealed. In this instance, the resulting poker hand 672 does not meet a minimum paytable criteria when evaluated. Hence, no multiplier or bonus wild symbols are awarded for the next gaming event. Referring to FIG. 6C, a second gaming event has been played and is displayed in the gaming grid 610. Additionally, the virtual cards 670 associated with this second gaming event are collected, dealt and displayed in a poker hand 672. This time a flush is received when evaluating the bonus poker hand 672. This may cause predefined multipliers and bonus wilds to be activated for the next gaming event. Alternatively, the multiplier and/or the number of bonus wilds may be randomly selected from ranges associated with each poker hand outcome in the paytable used during the evaluation. In this instance, the player receives a “5×” multiplier and four bonus locking wild symbols in the next gaming event, as shown on the Multiplier meter 684 and Bonus Wild meter 686.

Referring to FIG. 6D, the four bonus locking wild symbols 625 are randomly placed on the game grid 610 and the game reels are spun when a third gaming event is initiated. Additionally, the “5×” multiplier is activated and available to multiply any awards won during the third gaming event. Referring to FIG. 6E, the result of the third gaming event is shown on the game grid 610 (note that the virtual cards collected and dealt for this third gaming event have not yet been revealed, but will be). In this instance, the locked wild symbols 625 on the game grid 610 have helped create two five-symbol Triple Bars combinations along game paylines. The awards associated with those five-symbol wins are then multiplied by the active “5×” multiplier and the total award is shown in the Paid meter 608.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out above and in the appended claims.

1. A gaming device comprising:
a video display device configured to display a game grid showing respective portions of a plurality of game reels each having a plurality of game symbols;
a memory device configured to store a credit amount;
a wager input device structured to receive physical items associated with a currency value; and
a processor operable to:
receive a signal from the wager input device indicating receipt of a physical item associated with a currency value;
increase the credit amount stored in the memory based on the currency value of the received physical item;
receive a wager on a gaming event, an amount of the wager deducted from the credit amount stored in the memory;
display a randomly chosen first set of game symbols in the game grid as a primary game outcome of the gaming event;
evaluate the primary game outcome of the gaming event for base-game awards;
select a virtual playing card to add to a collection area where a plurality of virtual playing cards can be collected and stored;
determine if a bonus evaluation process has been triggered; and
when the bonus evaluation process has been triggered:
select a plurality of the collected playing cards in the collection area to deal into a poker hand,
evaluate the dealt poker hand to determine a bonus value, and
display the determined bonus value.

2. The gaming device of claim 1, wherein the bonus value associated with the evaluation of the dealt poker hand is a credit amount.

3. The gaming device of claim 2, wherein the credit amount determined as part of the bonus value is added to the determined base-game awards.

4. The gaming device of claim 1, wherein the bonus value associated with the evaluation of the dealt poker hand is a multiplier.

5. The gaming device of claim 4, wherein the multiplier determined as part of the bonus value is used to multiply the determined base-game awards.

6. The gaming device of claim 4, wherein the multiplier determined as part of the bonus value is used to multiply awards received in a future gaming event.

7. The gaming device of claim 1, wherein the poker hand dealt in the bonus evaluation process is a 5-card stud poker hand.

8. The gaming device of claim 1, wherein the poker hand dealt in the bonus evaluation process is a 5-card draw poker hand.

9. The gaming device of claim 8, wherein replacement cards for the dealt draw poker hand are selected from remaining cards of the collected playing cards in the collection area.

10. The gaming device of claim 8, wherein replacement cards for the dealt draw poker hand are selected from a separate deck of virtual cards.
